(19) United States
(12) Patent Application Publication
(10) Pub. No.: US 2023/0353401 A1
(43) Pub. Date: Nov. 2, 2023

(54) PROVIDING PRESENCE IN PERSISTENT HYBRID VIRTUAL COLLABORATIVE WORKSPACES

(71) Applicant: Zoom Video Communications, Inc., San Jose, CA (US)

(72) Inventors: Ross Douglas Mayfield, Palo Alto, CA (US); Robert Allen Ryskamp, Mountain View, CA (US); Jeffrey William Smith, Layton, UT (US)

(21) Appl. No.: 17/733,394

(22) Filed: Apr. 29, 2022

(51) Int. Cl. H04L 12/18

(52) U.S. Cl. CPC H04L 12/1822; H04L 12/1818

(57) ABSTRACT

One example method includes receiving, from a client device by a conference provider, a request to join a virtual space hosted by the conference provider, the virtual space having a plurality of members, the client device associated with a first member of the plurality of members; joining the client device to the virtual space; establishing a presence associated with the first member based on an interaction of the first member with the virtual space, the presence indicating whether the first member is present in the virtual space and a context; and providing an indication of the presence to the other members of the plurality of members

### FIELD

The present application generally relates to virtual workspaces and more generally relates to providing presence in persistent hybrid virtual collaborative workspaces.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIGS. 1-3 show example systems for providing presence in persistent hybrid virtual collaborative workspaces;

FIGS. 4-6 show example graphical user interfaces (“GUIs”) for providing presence in persistent hybrid virtual collaborative workspaces;

FIG. 7 shows an example client device for providing presence in persistent hybrid virtual collaborative workspaces;

FIGS. 8-11 show example graphical user interfaces (“GUIs”) for providing presence in persistent hybrid virtual collaborative workspaces;

FIG. 12 shows an example method for providing presence in persistent hybrid virtual collaborative workspaces; and

FIG. 13 shows an example computing device suitable for use with various systems and methods for providing presence in persistent hybrid virtual collaborative workspaces.

### DETAILED DESCRIPTION

Examples are described herein in the context of providing presence in persistent hybrid virtual collaborative workspaces. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

While working on a project or with a team, people may engage in various types of interactions, such as meetings with other team members and generating or revising documents. In a physical office setting, these may be accomplished by in-person interactions, such as in a conference room or by visiting a team members office or work area. However, in settings where team members are remote from each other or may be working from home or other non-office locations, in-person interactions may be impractical. Thus, virtual replacements may be used, such as video conferences or emailing documents amongst team members. However, the sense of collaboration or membership on a team may be diminished when team members are not able to interact in person. In addition, the team's ability to organize itself may be affected since working remotely distributes information and knowledge across different physical locations without a centralized location for the team to collaborate.

To help address these issues, a video conference provider may provide functionality to allow a team to create a virtual “space” within which the team can work and interact. For example, documents, notes, chats, and meetings may be held within the space. Further, each of these may be accessible to the other members of the space at any time, subject to any access restrictions that may be imposed. As team members perform their various tasks, they may “enter” the space to access documents or other materials. While they are “within” the space, they may be able to determine who else is present within the space and, if they would like, they can start an interaction with another team member, such as by starting an impromptu meeting with the other team member or by entering a chat message. In addition, the team member may see what other meetings may be occurring and between whom. They can then join or listen in to an on-going meeting if it looks to be of interest.

In addition, the virtual space can be attached to a physical location, such as a conference room that is equipped with video conferencing equipment. People within the conference room can connect to the space and physically work in the conference room with the resources available within the space. In addition, they can engage in video conferences with other members of the space, either via a scheduled video conference or through an impromptu meeting with one or more other team members. Or they can join an on-going meeting that's visible within the space, even without an invitation. Depending on the nature of the space and the conference room, the connection between the two may be persistently maintained so that when people are working within the conference room, other team members within the space can see that there is activity in the conference room and virtually “join” the conference room via a video conference.

Over time, as the team interacts with each other or adds or modifies content within the space, the space tracks the interactions and can store those interactions within the space for later review. For example, when team members engage in a meeting within the space, the space may record the meeting and store the recording within the space, or it may generate a transcript of the meeting and store the transcript within the space. Similarly, the space may archive chat messages over time, such as after a week, and allow team members to access old chats to review what was discussed. Thus, the space provides not only a repository for the team's resources and work product, but also an interaction space within which the team members can interact more like they are physically present within the same location. The space also serves as an archivist that monitors and records communications and other interactions that may occur within the space. Thus, the space provides a centralized “location” where team interactions and work can take place, despite team members being geographically distant from each other.

However, because a virtual space is intended to emulate a real “physical” location, members of the space can be virtually “present” in the space. Presence in a virtual space indicates that the particular member is not only logged into the video conference provider, but also that they are focused on the space and are interacting with it in some fashion. For example, a member of the space who is engaging in a text chat with other members of the space will be identified as “present” within the space. Similarly, a member of the space who is participating in a virtual meeting attached to the space will be identified as “present” in the space.

As an analog to physical presence, a member can typically only be present in a single space at a time, similar to how a person can only be present in one physical location at a time. While a user can be a member of multiple different spaces concurrently, they will only be able to have one active at a time. For example, they may open multiple virtual spaces within a virtual conferencing client, but select one in which to work at a particular time. As a consequence, the other virtual spaces will be pushed into the background, both in terms of their client device's processing but also in terms of their attention or focus. By doing so, the user establishes their presence within the selected virtual space.

When a user has “entered” or is present within a virtual space, other members of the space can see that they are present, such as within a roster presented in a GUI view of the space or another indicator displayed within the space. They may be able to obtain more detailed information about the nature of the member's presence as well. For example, a member may be present in the space, but may be occupied, such as in a virtual meeting, working in an application, or collaborating with one or more other members. Thus, the user's presence may indicate whether they are within the space as well as what they may be doing within the space. Similar to a physical workspace where a person may walk by another person work area, such as an office or cubicle, and see whether the person appears to be free to interact or is occupied with some task.

Unlike more generalized “away” or “online” indicators, a member's presence provides both a more informative indication of the member's current status, but also can affect how other members of a space can interact with the member. For example, a member who is present in a space can be interacted with via impromptu communications, such as via text messaging or a video meeting, or they may be pulled into on-going meetings or collaborations. However, if the member is present but occupied with a something within the space, other members can see their status (subject to privacy options a member might select) and either try them again later or interrupt them for a desired type of interaction. Alternatively, a member may not be present in the space, but may still be available for interactions; however, members of the space may be restricted in how they can interact with such a member. Still other types of presences may be employed to enable other members of the space to find a particular team member and interact with them in any of a variety of ways. Thus, a team member's presence within a virtual space may affect the types of interactions or other functionality that may be employed with respect to that team member within the space.

By providing the notion of presence to a virtual collaborative workspace, a team may work together more collaboratively and seamlessly. It may foster more intra-team collaboration and communication, and may enable team members to better understand how other team members are occupied before attempting to interact with them.

This illustrative example is given to introduce the reader to the general subject matter discussed herein and the disclosure is not limited to this example. The following sections describe various additional non-limiting examples and examples of providing presence in persistent hybrid virtual collaborative workspaces.

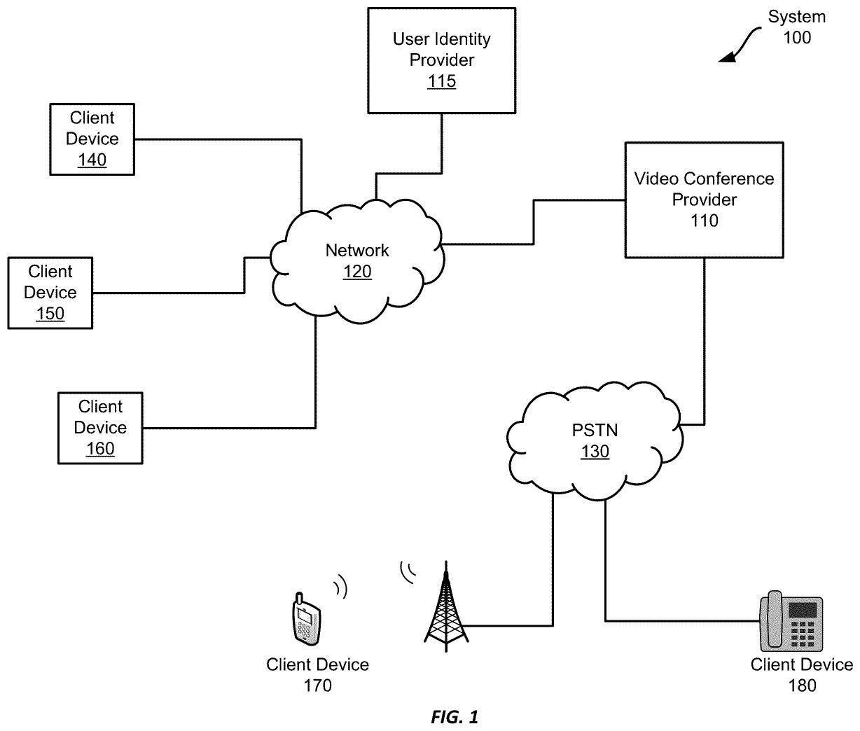

Referring now to FIG. 1, FIG. 1 shows an example system 100 that provides videoconferencing functionality to various client devices. The system 100 includes a video conference provider 110 that is connected to multiple communication networks 120, 130, through which various client devices 140-180 can participate in video conferences hosted by the video conference provider 110. For example, the video conference provider 120 can be located within a private network to provide video conferencing services to devices within the private network, or it can be connected to a public network, e.g., the internet, so it may be accessed by anyone. Some examples may even provide a hybrid model in which a video conference provider 120 may supply components to enable a private organization to host private internal video conferences or to connect its system to the video conference provider 120 over a public network.

The system optionally also includes one or more user identity providers, e.g., user identity provider 115, which can provide user identity services to users of the client devices 140-160 and may authenticate user identities of one or more users to the video conference provider 110. In this example, the user identity provider 115 is operated by a different entity than the video conference provider 110, though in some examples, they may be the same entity.

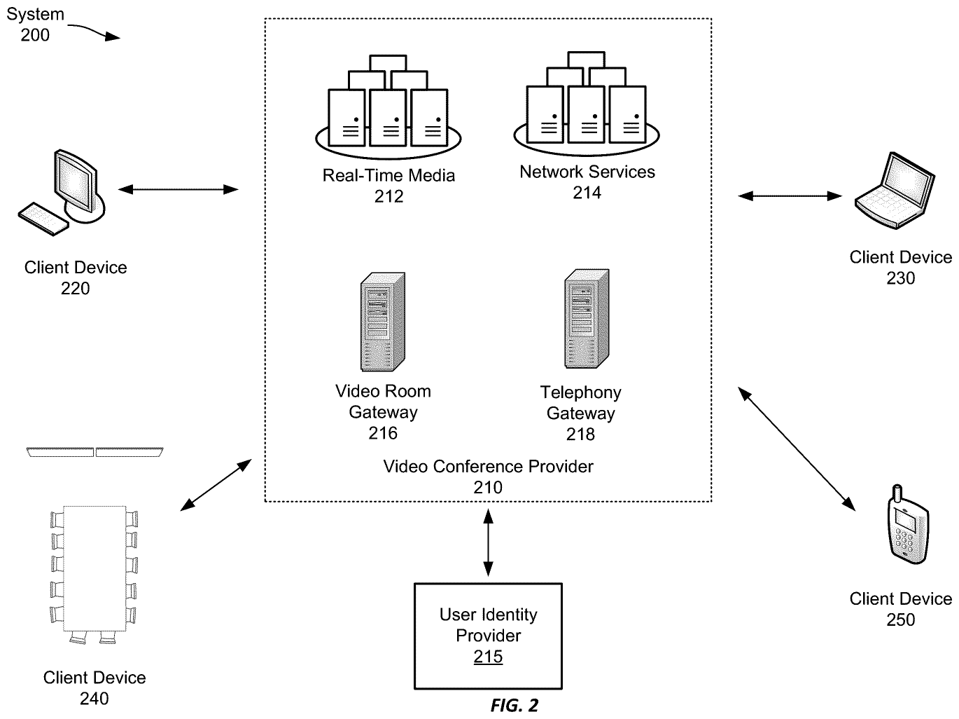

Video conference provider 110 allows clients to create videoconference meetings (or “meetings”) and invite others to participate in those meetings as well as perform other related functionality, such as recording the meetings, generating transcripts from meeting audio, manage user functionality in the meetings, enable text messaging during the meetings, create and manage breakout rooms from the main meeting, etc. FIG. 2, described below, provides a more detailed description of the architecture and functionality of the video conference provider 110.

Meetings in this example video conference provider 110 are provided in virtual “rooms” to which participants are connected. The room in this context is a construct provided by a server that provides a common point at which the various video and audio data is received before being multiplexed and provided to the various participants. While a “room” is the label for this concept in this disclosure, any suitable functionality that enables multiple participants to participate in a common videoconference may be used. Further, in some examples, and as alluded to above, a meeting may also have “breakout” rooms. Such breakout rooms may also be rooms that are associated with a “main” videoconference room. Thus, participants in the main videoconference room may exit the room into a breakout room, e.g., to discuss a particular topic, before returning to the main room. The breakout rooms in this example are discrete meetings that are associated with the meeting in the main room. However, to join a breakout room, a participant must first enter the main room. A room may have any number of associated breakout rooms according to various examples.

To create a meeting with the video conference provider 110, a user may contact the video conference provider 110 using a client device 140-180 and select an option to create a new meeting. Such an option may be provided in a webpage accessed by a client device 140-160 or client application executed by a client device 140-160. For telephony devices, the user may be presented with an audio menu that they may navigate by pressing numeric buttons on their telephony device. To create the meeting, the video conference provider 110 may prompt the user for certain information, such as a date, time, and duration for the meeting, a number of participants, a type of encryption to use, whether the meeting is confidential or open to the public, etc. After receiving the various meeting settings, the video conference provider may create a record for the meeting and generate a meeting identifier and, in some examples, a corresponding meeting password or passcode (or other authentication information), all of which meeting information is provided to the meeting host.

After receiving the meeting information, the user may distribute the meeting information to one or more users to invite them to the meeting. To begin the meeting at the scheduled time (or immediately, if the meeting was set for an immediate start), the host provides the meeting identifier and, if applicable, corresponding authentication information (e.g., a password or passcode). The video conference system then initiates the meeting and may admit users to the meeting. Depending on the options set for the meeting, the users may be admitted immediately upon providing the appropriate meeting identifier (and authentication information, as appropriate), even if the host has not yet arrived, or the users may be presented with information indicating that the meeting has not yet started or the host may be required to specifically admit one or more of the users.

During the meeting, the participants may employ their client devices 140-180 to capture audio or video information and stream that information to the video conference provider 110. They also receive audio or video information from the video conference provider 210, which is displayed by the respective client device 140 to enable the various users to participate in the meeting.

At the end of the meeting, the host may select an option to terminate the meeting, or it may terminate automatically at a scheduled end time or after a predetermined duration. When the meeting terminates, the various participants are disconnected from the meeting, and they will no longer receive audio or video streams for the meeting (and will stop transmitting audio or video streams). The video conference provider 110 may also invalidate the meeting information, such as the meeting identifier or password/passcode.

To provide such functionality, one or more client devices 140-180 may communicate with the video conference provider 110 using one or more communication networks, such as network 120 or the public switched telephone network (“PSTN”) 130. The client devices 140-180 may be any suitable computing or communications device that have audio or video capability. For example, client devices 140-160 may be conventional computing devices, such as desktop or laptop computers having processors and computer-readable media, connected to the video conference provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more users to participate in a video conference meeting hosted by the video conference provider 110.

In addition to the computing devices discussed above, client devices 140-180 may also include one or more telephony devices, such as cellular telephones (e.g., cellular telephone 170), internet protocol (“IP”) phones (e.g., telephone 180), or conventional telephones. Such telephony devices may allow a user to make conventional telephone calls to other telephony devices using the PSTN, including the video conference provider 110. It should be appreciated that certain computing devices may also provide telephony functionality and may operate as telephony devices. For example, smartphones typically provide cellular telephone capabilities and thus may operate as telephony devices in the example system 100 shown in FIG. 1. In addition, conventional computing devices may execute software to enable telephony functionality, which may allow the user to make and receive phone calls, e.g., using a headset and microphone. Such software may communicate with a PSTN gateway to route the call from a computer network to the PSTN. Thus, telephony devices encompass any devices that can make conventional telephone calls and is not limited solely to dedicated telephony devices like conventional telephones.

Referring again to client devices 140-160, these devices 140-160 contact the video conference provider 110 using network 120 and may provide information to the video conference provider 110 to access functionality provided by the video conference provider 110, such as access to create new meetings or join existing meetings. To do so, the client devices 140-160 may provide user identification information, meeting identifiers, meeting passwords or passcodes, etc. In examples that employ a user identity provider 115, a client device, e.g., client devices 140-160, may operate in conjunction with a user identity provider 115 to provide user identification information or other user information to the video conference provider 110.

A user identity provider 115 may be any entity trusted by the video conference provider 110 that can help identify a user to the video conference provider 110. For example, a trusted entity may be a server operated by a business or other organization and with whom the user has established their identity, such as an employer or trusted third-party. The user may sign into the user identity provider 115, such as by providing a username and password, to access their identity at the user identity provider 115. The identity, in this sense, is information established and maintained at the user identity provider 115 that can be used to identify a particular user, irrespective of the client device they may be using. An example of an identity may be an email account established at the user identity provider 110 by the user and secured by a password or additional security features, such as biometric authentication, two-factor authentication, etc. However, identities may be distinct from functionality such as email. For example, a health care provider may establish identities for its patients. And while such identities may have associated email accounts, the identity is distinct from those email accounts. Thus, a user's “identity” relates to a secure, verified set of information that is tied to a particular user and should be accessible only by that user. By accessing the identity, the associated user may then verify themselves to other computing devices or services, such as the video conference provider 110.

When the user accesses the video conference provider 110 using a client device, the video conference provider 110 communicates with the user identity provider 115 using information provided by the user to verify the user's identity. For example, the user may provide a username or cryptographic signature associated with a user identity provider 115. The user identity provider 115 then either confirms the user's identity or denies the request. Based on this response, the video conference provider 110 either provides or denies access to its services, respectively.

For telephony devices, e.g., client devices 170-180, the user may place a telephone call to the video conference provider 110 to access video conference services. After the call is answered, the user may provide information regarding a video conference meeting, e.g., a meeting identifier (“ID”), a passcode or password, etc., to allow the telephony device to join the meeting and participate using audio devices of the telephony device, e.g., microphone(s) and speaker(s), even if video capabilities are not provided by the telephony device.

Because telephony devices typically have more limited functionality than conventional computing devices, they may be unable to provide certain information to the video conference provider 110. For example, telephony devices may be unable to provide user identification information to identify the telephony device or the user to the video conference provider 110. Thus, the video conference provider 110 may provide more limited functionality to such telephony devices. For example, the user may be permitted to join a meeting after providing meeting information, e.g., a meeting identifier and passcode, but they may be identified only as an anonymous participant in the meeting. This may restrict their ability to interact with the meetings in some examples, such as by limiting their ability to speak in the meeting, hear or view certain content shared during the meeting, or access other meeting functionality, such as joining breakout rooms or engaging in text chat with other participants in the meeting.

It should be appreciated that users may choose to participate in meetings anonymously and decline to provide user identification information to the video conference provider 110, even in cases where the user has an authenticated identity and employs a client device capable of identifying the user to the video conference provider 110. The video conference provider 110 may determine whether to allow such anonymous users to use services provided by the video conference provider 110. Anonymous users, regardless of the reason for anonymity, may be restricted as discussed above with respect to users employing telephony devices, and in some cases may be prevented from accessing certain meetings or other services, or may be entirely prevented from accessing the video conference provider 110.

Referring again to video conference provider 110, in some examples, it may allow client devices 140-160 to encrypt their respective video and audio streams to help improve privacy in their meetings. Encryption may be provided between the client devices 140-160 and the video conference provider 110 or it may be provided in an end-to-end configuration where multimedia streams transmitted by the client devices 140-160 are not decrypted until they are received by another client device 140-160 participating in the meeting. Encryption may also be provided during only a portion of a communication, for example encryption may be used for otherwise unencrypted communications that cross international borders.

Client-to-server encryption may be used to secure the communications between the client devices 140-160 and the video conference provider 110, while allowing the video conference provider 110 to access the decrypted multimedia streams to perform certain processing, such as recording the meeting for the participants or generating transcripts of the meeting for the participants. End-to-end encryption may be used to keep the meeting entirely private to the participants without any worry about a video conference provider 110 having access to the substance of the meeting. Any suitable encryption methodology may be employed, including key-pair encryption of the streams. For example, to provide end-to-end encryption, the meeting host's client device may obtain public keys for each of the other client devices participating in the meeting and securely exchange a set of keys to encrypt and decrypt multimedia content transmitted during the meeting. Thus, the client devices 140-160 may securely communicate with each other during the meeting. Further, in some examples, certain types of encryption may be limited by the types of devices participating in the meeting. For example, telephony devices may lack the ability to encrypt and decrypt multimedia streams. Thus, while encrypting the multimedia streams may be desirable in many instances, it is not required as it may prevent some users from participating in a meeting.

By using the example system shown in FIG. 1, users can create and participate in meetings using their respective client devices 140-180 via the video conference provider 110. Further, such a system enables users to use a wide variety of different client devices 140-180 from traditional standards-based video conferencing hardware to dedicated video conferencing equipment to laptop or desktop computers to handheld devices to legacy telephony devices, etc.

Referring now to FIG. 2, FIG. 2 shows an example system 200 in which a video conference provider 210 provides videoconferencing functionality to various client devices 220-250. The client devices 220-250 include two conventional computing devices 220-230, dedicated equipment for a video conference room 240, and a telephony device 250. Each client device 220-250 communicates with the video conference provider 210 over a communications network, such as the internet for client devices 220-240 or the PSTN for client device 250, generally as described above with respect to FIG. 1. The video conference provider 210 is also in communication with one or more user identity providers 215, which can authenticate various users to the video conference provider 210 generally as described above with respect to FIG. 1.

In this example, the video conference provider 210 employs multiple different servers (or groups of servers) to provide different aspects of video conference functionality, thereby enabling the various client devices to create and participate in video conference meetings. The video conference provider 210 uses one or more real-time media servers 212, one or more network services servers 214, one or more video room gateways 216, and one or more telephony gateways 218. Each of these servers 212-218 is connected to one or more communications networks to enable them to collectively provide access to and participation in one or more video conference meetings to the client devices 220-250.

The real-time media servers 212 provide multiplexed multimedia streams to meeting participants, such as the client devices 220-250 shown in FIG. 2. While video and audio streams typically originate at the respective client devices, they are transmitted from the client devices 220-250 to the video conference provider 210 via one or more networks where they are received by the real-time media servers 212. The real-time media servers 212 determine which protocol is optimal based on, for example, proxy settings and the presence of firewalls, etc. For example, the client device might select among UDP, TCP, TLS, or HTTPS for audio and video and UDP for content screen sharing.

The real-time media servers 212 then multiplex the various video and audio streams based on the target client device and communicate multiplexed streams to each client device. For example, the real-time media servers 212 receive audio and video streams from client devices 220-240 and only an audio stream from client device 250. The real-time media servers 212 then multiplex the streams received from devices 230-250 and provide the multiplexed streams to client device 220. The real-time media servers 212 are adaptive, for example, reacting to real-time network and client changes, in how they provide these streams. For example, the real-time media servers 212 may monitor parameters such as a client's bandwidth CPU usage, memory and network I/O as well as network parameters such as packet loss, latency and jitter to determine how to modify the way in which streams are provided.

The client device 220 receives the stream, performs any decryption, decoding, and demultiplexing on the received streams, and then outputs the audio and video using the client device's video and audio devices. In this example, the real-time media servers do not multiplex client device 220's own video and audio feeds when transmitting streams to it. Instead, each client device 220-250 only receives multimedia streams from other client devices 220-250. For telephony devices that lack video capabilities, e.g., client device 250, the real-time media servers 212 only deliver multiplex audio streams. The client device 220 may receive multiple streams for a particular communication, allowing the client device 220 to switch between streams to provide a higher quality of service.

In addition to multiplexing multimedia streams, the real-time media servers 212 may also decrypt incoming multimedia stream in some examples. As discussed above, multimedia streams may be encrypted between the client devices 220-250 and the video conference system 210. In some such examples, the real-time media servers 212 may decrypt incoming multimedia streams, multiplex the multimedia streams appropriately for the various clients, and encrypt the multiplexed streams for transmission.

In some examples, to provide multiplexed streams, the video conference provider 210 may receive multimedia streams from the various participants and publish those streams to the various participants to subscribe to and receive. Thus, the video conference provider 210 notifies a client device, e.g., client device 220, about various multimedia streams available from the other client devices 230-250, and the client device 220 can select which multimedia stream(s) to subscribe to and receive. In some examples, the video conference provider 210 may provide to each client device the available streams from the other client devices, but from the respective client device itself, though in other examples it may provide all available streams to all available client devices. Using such a multiplexing technique, the video conference provider 210 may enable multiple different streams of varying quality, thereby allowing client devices to change streams in real-time as needed, e.g., based on network bandwidth, latency, etc.

As mentioned above with respect to FIG. 1, the video conference provider 210 may provide certain functionality with respect to unencrypted multimedia streams at a user's request. For example, the meeting host may be able to request that the meeting be recorded or that a transcript of the audio streams be prepared, which may then be performed by the real-time media servers 212 using the decrypted multimedia streams, or the recording or transcription functionality may be off-loaded to a dedicated server (or servers), e.g., cloud recording servers, for recording the audio and video streams. In some examples, the video conference provider 210 may allow a meeting participant to notify it of inappropriate behavior or content in a meeting. Such a notification may trigger the real-time media servers to 212 record a portion of the meeting for review by the video conference provider 210. Still other functionality may be implemented to take actions based on the decrypted multimedia streams at the video conference provider, such as monitoring video or audio quality, adjusting or changing media encoding mechanisms, etc.

It should be appreciated that multiple real-time media servers 212 may be involved in communicating data for a single meeting and multimedia streams may be routed through multiple different real-time media servers 212. In addition, the various real-time media servers 212 may not be co-located, but instead may be located at multiple different geographic locations, which may enable high-quality communications between clients that are dispersed over wide geographic areas, such as being located in different countries or on different continents. Further, in some examples, one or more of these servers may be co-located on a client's premises, e.g., at a business or other organization. For example, different geographic regions may each have one or more real-time media servers 212 to enable client devices in the same geographic region to have a high-quality connection into the video conference provider 210 via local servers 212 to send and receive multimedia streams, rather than connecting to a real-time media server located in a different country or on a different continent. The local real-time media servers 212 may then communicate with physically distant servers using high-speed network infrastructure, e.g., internet backbone network(s), that otherwise might not be directly available to client devices 220-250 themselves. Thus, routing multimedia streams may be distributed throughout the video conference system 210 and across many different real-time media servers 212.

Turning to the network services servers 214, these servers 214 provide administrative functionality to enable client devices to create or participate in meetings, send meeting invitations, create or manage user accounts or subscriptions, and other related functionality. Further, these servers may be configured to perform different functionalities or to operate at different levels of a hierarchy, e.g., for specific regions or localities, to manage portions of the video conference provider under a supervisory set of servers. When a client device 220-250 accesses the video conference provider 210, it will typically communicate with one or more network services servers 214 to access their account or to participate in a meeting.

When a client device 220-250 first contacts the video conference provider 210 in this example, it is routed to a network services server 214. The client device may then provide access credentials for a user, e.g., a username and password or single sign-on credentials, to gain authenticated access to the video conference provider 210. This process may involve the network services servers 214 contacting a user identity provider 215 to verify the provided credentials. Once the user's credentials have been accepted, the client device 214 may perform administrative functionality, like updating user account information, if the user has an identity with the video conference provider 210, or scheduling a new meeting, by interacting with the network services servers 214.

In some examples, users may access the video conference provider 210 anonymously. When communicating anonymously, a client device 220-250 may communicate with one or more network services servers 214 but only provide information to create or join a meeting, depending on what features the video conference provider allows for anonymous users. For example, an anonymous user may access the video conference provider using client 220 and provide a meeting ID and passcode. The network services server 214 may use the meeting ID to identify an upcoming or on-going meeting and verify the passcode is correct for the meeting ID. After doing so, the network services server(s) 214 may then communicate information to the client device 220 to enable the client device 220 to join the meeting and communicate with appropriate real-time media servers 212.

In cases where a user wishes to schedule a meeting, the user (anonymous or authenticated) may select an option to schedule a new meeting and may then select various meeting options, such as the date and time for the meeting, the duration for the meeting, a type of encryption to be used, one or more users to invite, privacy controls (e.g., not allowing anonymous users, preventing screen sharing, manually authorize admission to the meeting, etc.), meeting recording options, etc. The network services servers 214 may then create and store a meeting record for the scheduled meeting. When the scheduled meeting time arrives (or within a threshold period of time in advance), the network services server(s) 214 may accept requests to join the meeting from various users.

To handle requests to join a meeting, the network services server(s) 214 may receive meeting information, such as a meeting ID and passcode, from one or more client devices 220-250. The network services server(s) 214 locate a meeting record corresponding to the provided meeting ID and then confirm whether the scheduled start time for the meeting has arrived, whether the meeting host has started the meeting, and whether the passcode matches the passcode in the meeting record. If the request is made by the host, the network services server(s) 214 activates the meeting and connects the host to a real-time media server 212 to enable the host to begin sending and receiving multimedia streams.

Once the host has started the meeting, subsequent users requesting access will be admitted to the meeting if the meeting record is located and the passcode matches the passcode supplied by the requesting client device 220-250. In some examples additional access controls may be used as well. But if the network services server(s) 214 determines to admit the requesting client device 220-250 to the meeting, the network services server 214 identifies a real-time media server 212 to handle multimedia streams to and from the requesting client device 220-250 and provides information to the client device 220-250 to connect to the identified real-time media server 212. Additional client devices 220-250 may be added to the meeting as they request access through the network services server(s) 214.

After joining a meeting, client devices will send and receive multimedia streams via the real-time media servers 212, but they may also communicate with the network services servers 214 as needed during meetings. For example, if the meeting host leaves the meeting, the network services server(s) 214 may appoint another user as the new meeting host and assign host administrative privileges to that user. Hosts may have administrative privileges to allow them to manage their meetings, such as by enabling or disabling screen sharing, muting or removing users from the meeting, creating sub-meetings or “break-out” rooms, recording meetings, etc. Such functionality may be managed by the network services server(s) 214.

For example, if a host wishes to remove a user from a meeting, they may identify the user and issue a command through a user interface on their client device. The command may be sent to a network services server 214, which may then disconnect the identified user from the corresponding real-time media server 212. If the host wishes to create a break-out room for one or more meeting participants to join, such a command may also be handled by a network services server 214, which may create a new meeting record corresponding to the break-out room and then connect one or more meeting participants to the break-out room similarly to how it originally admitted the participants to the meeting itself.

In addition to creating and administering on-going meetings, the network services server(s) 214 may also be responsible for closing and tearing-down meetings once they have completed. For example, the meeting host may issue a command to end an on-going meeting, which is sent to a network services server 214. The network services server 214 may then remove any remaining participants from the meeting, communicate with one or more real time media servers 212 to stop streaming audio and video for the meeting, and deactivate, e.g., by deleting a corresponding passcode for the meeting from the meeting record, or delete the meeting record(s) corresponding to the meeting. Thus, if a user later attempts to access the meeting, the network services server(s) 214 may deny the request.

Depending on the functionality provided by the video conference provider, the network services server(s) 214 may provide additional functionality, such as by providing private meeting capabilities for organizations, special types of meetings (e.g., webinars), etc. Such functionality may be provided according to various examples of video conferencing providers according to this description.

Referring now to the video room gateway servers 216, these servers 216 provide an interface between dedicated video conferencing hardware, such as may be used in dedicated video conferencing rooms. Such video conferencing hardware may include one or more cameras and microphones and a computing device designed to receive video and audio streams from each of the cameras and microphones and connect with the video conference provider 210. For example, the video conferencing hardware may be provided by the video conference provider to one or more of its subscribers, which may provide access credentials to the video conferencing hardware to use to connect to the video conference provider 210.

The video room gateway servers 216 provide specialized authentication and communication with the dedicated video conferencing hardware that may not be available to other client devices 220-230, 250. For example, the video conferencing hardware may register with the video conference provider 210 when it is first installed and the video room gateway servers 216 may authenticate the video conferencing hardware using such registration as well as information provided to the video room gateway server(s) 216 when dedicated video conferencing hardware connects to it, such as device ID information, subscriber information, hardware capabilities, hardware version information etc. Upon receiving such information and authenticating the dedicated video conferencing hardware, the video room gateway server(s) 216 may interact with the network services servers 214 and real-time media servers 212 to allow the video conferencing hardware to create or join meetings hosted by the video conference provider 210.

Referring now to the telephony gateway servers 218, these servers 218 enable and facilitate telephony devices' participation in meetings hosed by the video conference provider 210. Because telephony devices communicate using the PSTN and not using computer networking protocols, such as TCP/IP, the telephony gateway servers 218 act as an interface that converts between the PSTN and the networking system used by the video conference provider 210.

For example, if a user uses a telephony device to connect to a meeting, they may dial a phone number corresponding to one of the video conference provider's telephony gateway servers 218. The telephony gateway server 218 will answer the call and generate audio messages requesting information from the user, such as a meeting ID and passcode. The user may enter such information using buttons on the telephony device, e.g., by sending dual-tone multi-frequency (“DTMF”) audio signals to the telephony gateway server 218. The telephony gateway server 218 determines the numbers or letters entered by the user and provides the meeting ID and passcode information to the network services servers 214, along with a request to join or start the meeting, generally as described above. Once the telephony client device 250 has been accepted into a meeting, the telephony gateway server 218 is instead joined to the meeting on the telephony device's behalf.

After joining the meeting, the telephony gateway server 218 receives an audio stream from the telephony device and provides it to the corresponding real-time media server 212, and receives audio streams from the real-time media server 212, decodes them, and provides the decoded audio to the telephony device. Thus, the telephony gateway servers 218 operate essentially as client devices, while the telephony device operates largely as an input/output device, e.g., a microphone and speaker, for the corresponding telephony gateway server 218, thereby enabling the user of the telephony device to participate in the meeting despite not using a computing device or video.

It should be appreciated that the components of the video conference provider 210 discussed above are merely examples of such devices and an example architecture. Some video conference providers may provide more or less functionality than described above and may not separate functionality into different types of servers as discussed above. Instead, any suitable servers and network architectures may be used according to different examples.

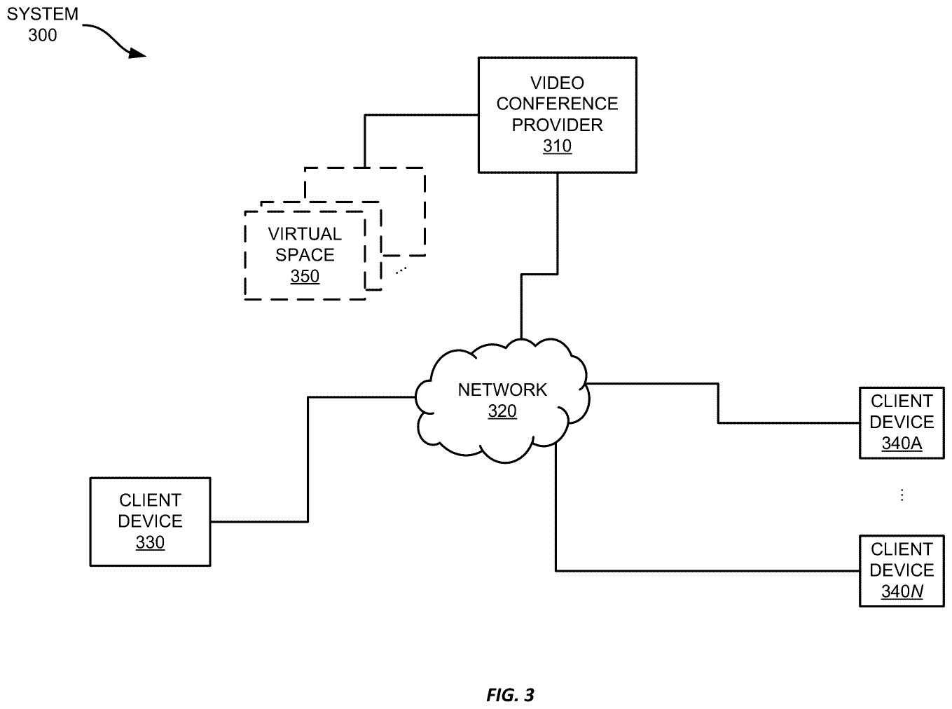

Referring now to FIG. 3, FIG. 3 shows an example system 300 for providing presence in persistent hybrid virtual collaborative workspaces. The system 300 shown in FIG. 3 includes a video conference provider 310 that has established and maintains multiple virtual spaces 350. The system 300 also includes multiple client device 330, 340a-n that are connected to the video conference provider 310 via a network 320. In this example, the network 320 is the internet; however, any communications network or combination of communications networks may be employed. And while the system 300 is depicted as including multiple client devices 330, 340a-n, it should be appreciated that some example systems may not include any client devices at any particular time. Rather, the video conference provider 310, which establishes and maintains virtual spaces 350 may be sufficient as a system for persistent hybrid virtual collaborative workspaces, to which one or more client devices 330, 340a-n may connect.

The video conference provider 310 establishes new spaces 350 at the request of corresponding users and stores one or more records in a database to represent the configuration and state of each space 350. For example, when a space is first established, it may not have any resources or members, other than the user who requested that the space be created. However, as documents, other users, meetings, or other content are added to or created within the space, the video conference provider 310 may add links or references to those resources or users. Thus, in some examples, the various resources may not be stored within the database or even stored by the video conference provider 310. Instead, the space provides a nexus through which such resources may be accessed, such as by traversing a universal resource locator (“URL”), by accessing a document within a document management system or stored in a local networked storage area. However, it should be appreciated that some examples may store individual resources as records within the database along with the configuration and state of the space itself.

Each of the spaces 350 established and maintained by the video conference provider 310 allows members of the respective space to connect to the space, interact with resources available within the space, and interact with other users that are connected to the space. However, each of the spaces 350 persists independently of whether any users are connected to the space or resources are available within the space. Thus, the space remains latent and available for use by any member of the space at any time.

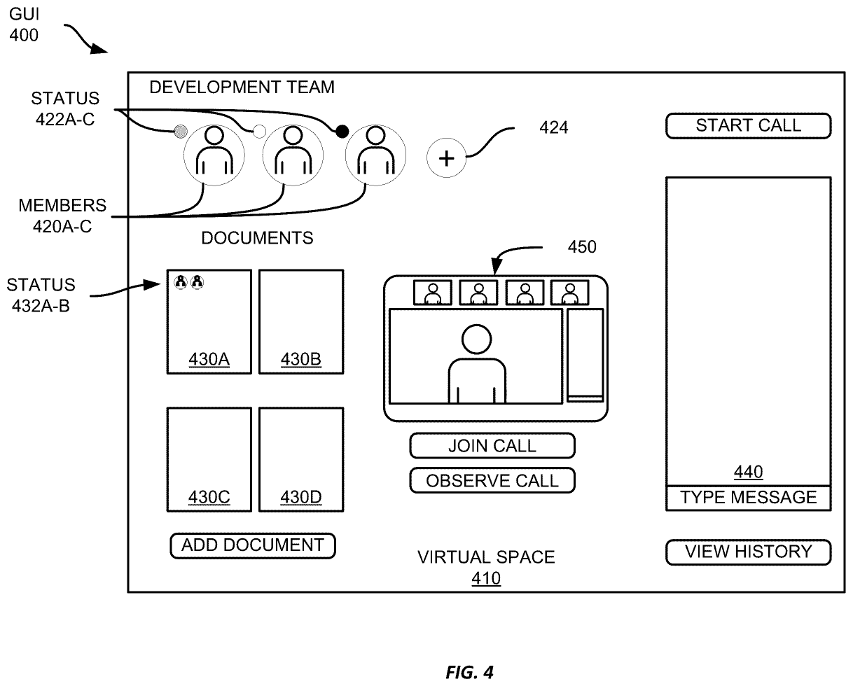

Referring now to FIG. 4, FIG. 4 shows a graphical user interface (“GUI”) 400 view of a virtual space 410 provided by the video conference provider 310. The virtual space 410 in this example has multiple team members 420a-c that have been added to the virtual space 410. In addition, the GUI 400 provides an option 424 to add additional users to the virtual space 410. The virtual space 410 has also been updated to include four documents 430a-d, which may be accessed by members of the virtual space 410. The virtual space 410 has also been configured to allow members 420a-c to add documents to the virtual space, such as by using the “Add Document” option or dragging a document onto the virtual space 410 within the GUI 400, and to create and participate in video conferences within the space by using the “Start Call” option. Similarly, when a video conference is in-progress within the virtual space 410, the GUI 400 provides a representation of the video conference 450. This allows members 420a-c of the space to see that a video conference is in-progress and who is within the video conference. The GUI 400 also provides the option to join the call via the “Join Call” button or to observe the call via the “Observe Call” button. The virtual space 410 has also been configured with chat functionality 440 to allow the members 440a-c to interact via text chat. Further, the virtual space 410 provides a “View History” option to allow the members 420a-c to view past events within the space, such as recordings of past video conferences, chat interactions, when team members have joined or left the space, or other events of interest.

In addition to providing access to the resources discussed above, the virtual space 410 can also provide status information to assist team members in understanding the current state of the virtual space. For example, as discussed above, the GUI 400 representation of the virtual space 410 provides a status indication that a video conference 450 is in-progress. In this example, the GUI 400 provides a static, stylized representation of a video conference, but the representation does not actually provide any content from the video conference. Instead, a team member 420a-c would need to join the video conference to obtain audio or video feeds or other information shared within the conference. However, in some examples the representation 450 may show the content of the video conference. Thus, the members 420a-c may be able to see the video feeds within the representation of the video conference 450 or, by selecting an option, may be able to hear the audio from the video conference without actually joining the video conference. When a member 420a-c is observing a video conference in such a manner, the participants within the video conference may be notified that the team member is observing the video conference. Further, some examples may provide options to activate a microphone and camera as an implicit command to join the meeting. Thus, a team member may observe an on-going conference and, if they elect to join, may simply activate their microphone and camera to join the meeting and begin contributing. Such functionality may more closely resemble an in-person meeting in a conference room where team members passing by may notice the meeting and spontaneously decide to join. Alternatively, the participants in the meeting may note that the team member is observing meeting and may send a request to the team member to join the meeting.

Other status information may be provided as well. For example, each of the team members is represented within the virtual space 410 by a stylized portrait 420a-c along with a corresponding status indicator 422a-c. The status indicators 422a-c may indicate the current presence of the team members 420a-c. For example, team member 420c has a dark status indicator 422c, indicating that the team member 420c is offline. Team member 420b has a bright status indicator 422a-c, indicating that they are online and active, while team member 420a has a dimmed status indicator 422a, indicating that they are online, but inactive. Thus, a team member can easily determine whether other team members are available for collaboration. However, examples discussed in more detail below may provide more detailed presence information Similarly, documents or other resources may provide indications of whether one or more members of the space is accessing the document or resource. For example, document 430a is being accessed by two members of the virtual space 410 as illustrated by status indicators 422a-b. To gain more information about which members are accessing the document, a user may select one of the status indicators 422a-c to obtain information about the corresponding member, such as the member's name. Still other status information may be provided according to other examples.

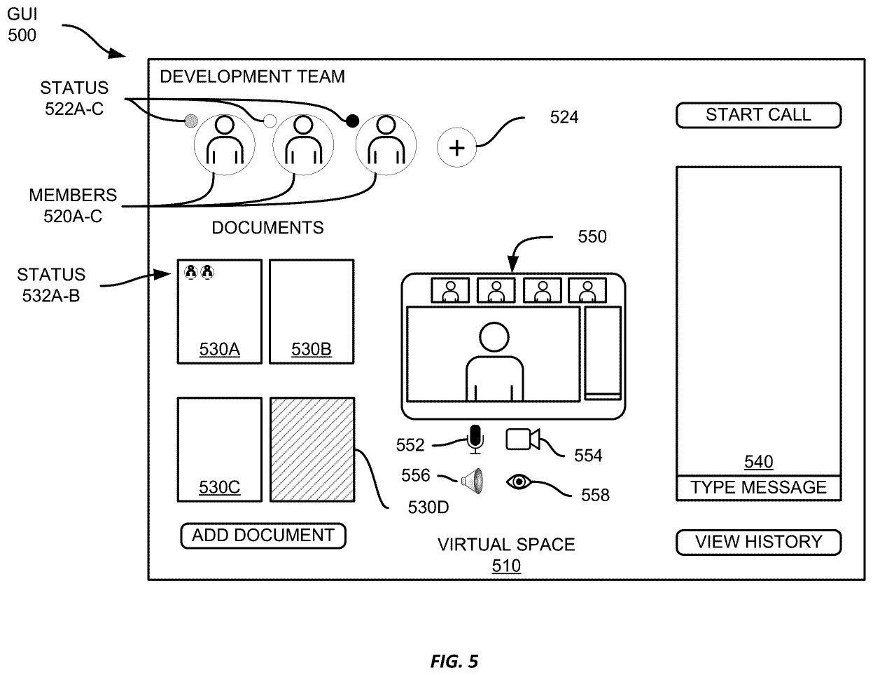

Referring now to FIG. 5, Figure shows another GUI 500 representation of a virtual space 510. The GUI 500 in this example includes many of the same features as those shown in FIG. 4, including multiple members 520a-c of the space and corresponding status indicators 522a-c, an option 524 to add members to the virtual space 510, multiple documents 530a-d and corresponding status indicators 522a-b, a chat window, and a representation of an on-going video conference 550. However, unlike the GUI 400 shown in FIG. 4, this representation of the virtual space 510 allows a user to seamlessly join the on-going video conference by selecting the options to activate a microphone 552 and activate a camera 554, or similarly may observe the conference by selecting the audio or eye icons 556, 558. Thus, the user may simply join the meeting by activating their input devices, or may only enable one or the other to speak without visually appearing in the video conference, or simply appear within the video conference without providing audio.

In addition to these differences, the virtual space 510 in this example has been configured to allow team members to apply permissions to different content within the virtual space 510. In this example, the user viewing the GUI 500 representation of the virtual space 500 is presented with four available documents 530a-d; however, document 530d has been shaded to indicate that the user does not have permission to view or otherwise access the document 530d. In some examples, however, if a team member does not have permission to access a document, the document may not be represented within their GUI 500 view of the virtual space 500, thus they may not be aware of its existence.

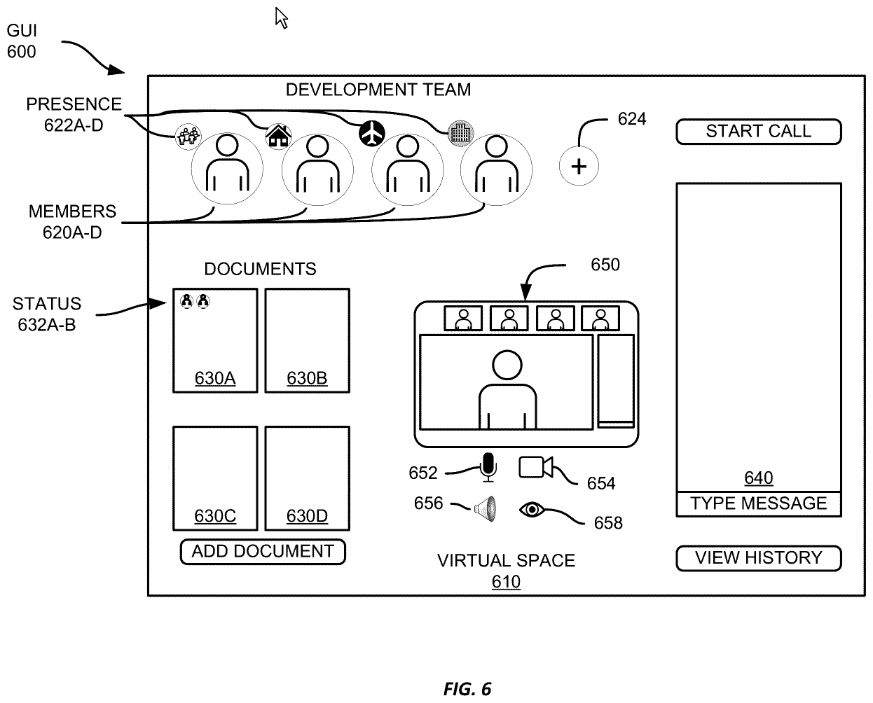

Referring now to FIG. 6, FIG. 6 shows a different example GUI for providing present in a persistent hybrid virtual collaborative space. In this example, the GUI 622 provides the features discussed above with respect to FIG. 4. However, the presence indicators 622a-d differ from the status indicators 422a-c, 522a-c in that they provide presence information rather than simply an indication of whether a person is online or offline, or actively using their device versus away from their device. In this example, four different presences are illustrated.

As is shown in FIG. 6, the presence indicators 622a-d provide a graphical indication of the corresponding member's presence associated with the virtual space 610. In this example, presence indicator 622a is bright (or a particular color, such as green), indicating that the corresponding member 620a is engaged with the virtual space 610, but also provides a graphical depiction of a meeting, indicating that they are in a meeting associated with the virtual space 610. Similarly, presence indicator 622b is also bright, but includes a graphical depiction of a house, indicating that the corresponding member 620b is present within the space, but is working from home.

Presence indicator 622c, in contrast, is darkened (or a different color, such as red) and includes an airplane icon, indicating that the member 620c is not present in the space, but also that they are travelling and not available at all for interactions. Finally, presence indicator 622d is somewhat darkened (or a still different color, such as yellow or orange), indicating that the member is online, but not present in the space 610. In addition, the presence indicator 622d includes a graphical representation of an office building, indicating that the member 620d is in the office, but not present in the space. Thus, they may be available for interaction, but may not respond immediately. Thus, the presence indicators 622a-d can provide a readily identifiable presence for each of the members in a virtual space 610. However, to provide the appropriate presence indicator 622a-d, the virtual conference provider receives information from virtual conferencing software executed on the members' client devices, e.g., client devices 330, 340a-n.

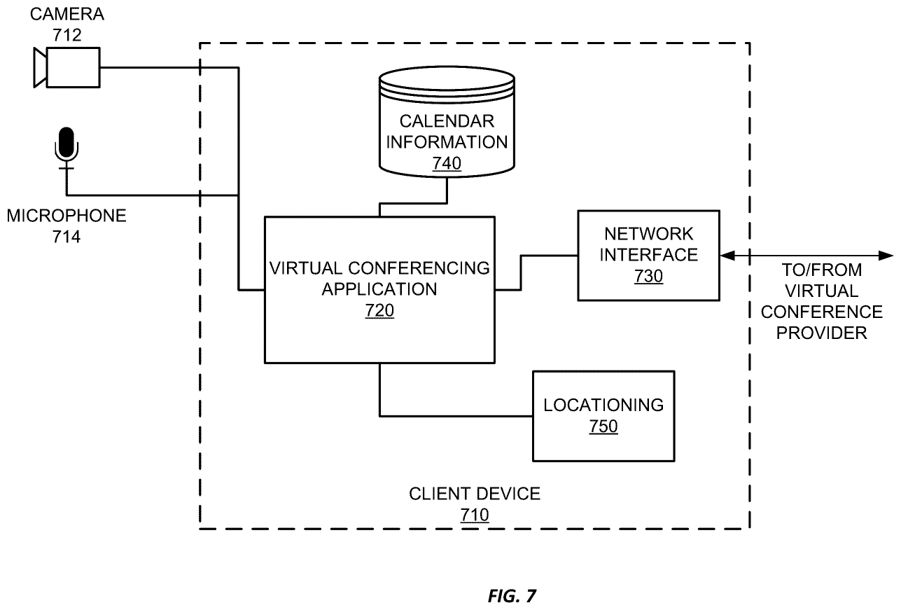

Referring now to FIG. 7, FIG. 7 shows an example client device 710 usable with various systems and methods for providing presence in persistent hybrid virtual collaborative workspaces. The client device 710 executes a virtual conferencing application 720 (or “client software 720”) to interact with the virtual conference provider via a network interface 730. The client software 720 also has access to a user's calendar information 740 and to a locationing system 750, such as a GPS or cellular device or functionality to determine or lookup location based on a network address, such as an internet protocol (“IP”) address.

When executing client software 720, the client software 720 communicates with the virtual conference provider, indicating that the member is at least connected to the virtual conference provider, which provides some presence information. But the client software 720 also is able to determine which spaces the member is connected to, and which are active within the client software, if any. Thus, the client software 720 is able to communicate status information for each space the user is a member of to the virtual conference provider. For example, if the user is a member of ten virtual spaces, has connected to five of the virtual spaces in the client software 720, and is actively working in one, the virtual conference provider may receive such information and generate a presence corresponding to the user for each of the ten virtual spaces based on the connection information.

In addition to the connection information, the client software 720 has access to the user's calendar information 740. Such information may be stored locally, such as is depicted in FIG. 7, or it may be stored at a remote server, such as at an email or calendar server. The client software 720 may access the calendar information to determine whether a user is occupied in a meeting, is traveling, or is apparently free. The client software 720 may provide such information to the virtual conference provider to enable more particularized presence information to be provided. The client software 720 can also obtain location information from the locationing system 750 to determine where the user is located, such as at home, in the office, or at another remote location. Such information may be provided to the virtual conference provider, which may synthesize all of the information to determine a user's presence with respect to the virtual spaces the user is a member of.

It should be appreciated that the user may control the granularity of the information provided to the virtual conference provider. For example, the user may allow the software client 720 to access their calendar information, but may only allow the software client 720 to communicate whether the user is in a meeting or not, or whether the meeting is attached to a particular virtual space or is independent of any virtual spaces the user is a member of. Similarly, the user may establish a setting within the client software 720 relating to the granularity of location information that may be provided. For example, the user may limit the location information to a particular city, state, region, or country. Or the user may provide a predefined list of locations that the user is willing to share, such as their home and office locations, but may otherwise prevent sharing of any other particular locations. Instead, the software client may communicate the user is “out of town” or “not at home or at work” instead of a particular location, if the user is not at their home or office.

In addition to the information communicated by the client software, the virtual conference provider may access information other information related to the user's presence. For example, the virtual conference provider may be able to determine whether the user is accessing one or more resources within the virtual space, such as a document or data. Similarly, the virtual conference provider may be able to determine whether the user is connected to a virtual meeting that is attached to a virtual space because such a virtual meeting may be hosted by the virtual conference provider.

Based on the information provided by the client device 710 and the information available to the virtual conference provider, the virtual conference provider can determine a presence for the user in each of the spaces the user is a member of. And as discussed above, the user's presence with respect to different virtual spaces may be different. Further, because only once space may be active at a time, in some examples, the user may only have an active presence in once virtual space at a time. Though some embodiments may allow the user to have two different virtual spaces open and active at the same time; however, the client software 720 may further communicate which of such spaces is in the software's foreground and which are not. Thus, even if multiple spaces are open simultaneously, the user's may only be actively present in one at any given time. Further, while the determination of presence above is performed by the virtual conference provider, in some examples, the client device 710 may determine a presence for the user with respect to one or more virtual spaces and provide presence information to the virtual conference provider. The virtual conference provider may then adopt that presence, or it may further determine a presence based on the received presence information alone or in combination with other information available to the virtual conference provider.

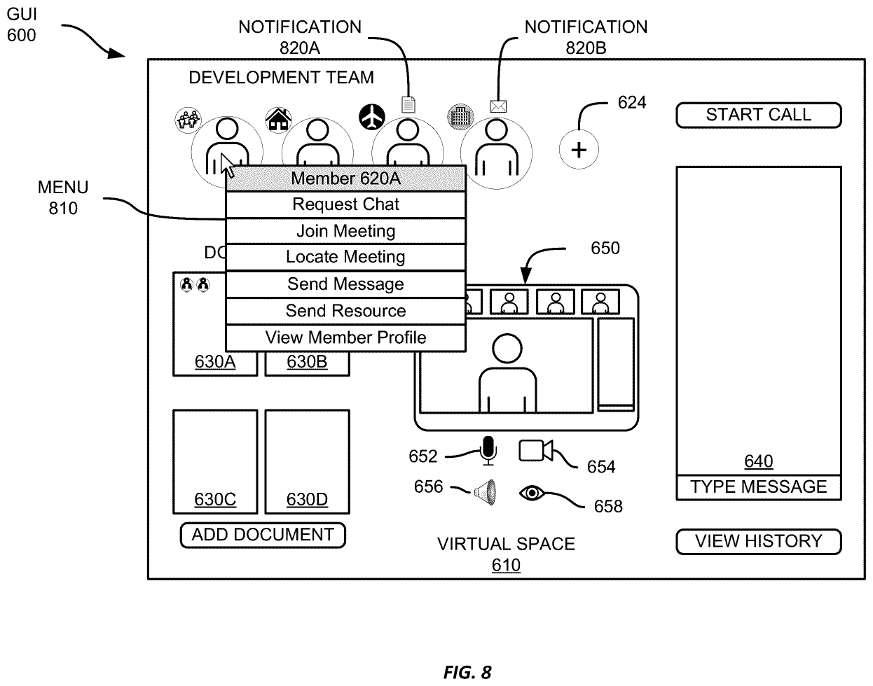

Referring now to FIG. 8, FIG. 8 illustrates an example GUI for providing presence in persistent hybrid virtual collaborative workspaces. In this example, the user interacts with one or more graphical representations of other members 620a-d of the virtual space and is able to select from available actions, which may differ depending on the member's presence within the virtual space 610.

As is shown in FIG. 8, the user has interacted with member 620a's representation within the virtual space 610 and is presented with a menu 810 of options for interacting with the member 620a. In this example, the member 620a is present in the virtual space 610, as discussed above with respect to FIG. 6, but is participating in a meeting, as indicated by the presence indicator 622a. Thus, the menu 810 is dynamically constructed based on the member's current presence. In this example, the menu 810 includes a first entry that identifies the member, i.e., member 620a. The menu is then populated with different options for interacting with the member 620a.

The first option is to Request Chat, which may open a private chat window, similar to the chat window 640 shown in the GUI 600. However, a private chat between members may be visible only to those members and not to the other members within the virtual space 610. The menu also allows the user to either join the meeting the member 620a is attending or to locate the meeting. In this example, the member 620a is in a meeting that is physically occurring in a conference room that is connected to the virtual space 610. Thus, the user can opt to join the meeting remotely by joining a video conference corresponding to the conference room. If one is not already in progress, a new video conference may be started. Alternatively, the user can request to locate the meeting so that they can physically attend the meeting by walking to the appropriate conference room.

Next, the user has the option to send a message or send a resource to the member 620a. For example, if the user does not wish to disturb the member 620a during the meeting, they may send a message to the user, but not initiate an interactive chat session. The message may be sent as an email in some examples, or it may be delivered as a private message via the space. The recipient may be presented with a notification 820b, such as the envelope icon shown adjacent to member 620d in the GUI 600. In different examples, the message may be text, an audio message, or a video message. The user may also send a resource to the member 620a, such as a document, link (e.g., a universal resource locator or “URL”), or app that is usable in the virtual space 610. Resources may be items that are associated with the space, such as one of the documents 630a-d shown in the GUI 600, or they may be documents obtained from another source external to the virtual space 600. Sending a resource may also result in a notification being displayed, such as the document icon for the notification 820a above member 620c.

The last option in the menu is to view the member's profile, which may provide information the member 620a allows other to view, such as their name and contact information (e.g., email address, username, or telephone number), role within the virtual space 610, presence status (e.g., that they are attending a meeting, working from home, etc.), apps or documents they are working with, or any other relevant information that the member 620a would like to share with other members of the virtual space 610.

The array of interactions presented in the menu 810 is based on the member's presence within the space. Because they are active in the space 610, but attending a meeting, interactive options, such as video or voice chats, are omitted from the menu 810, as are options to join the member 620a to new or on-going video conference.

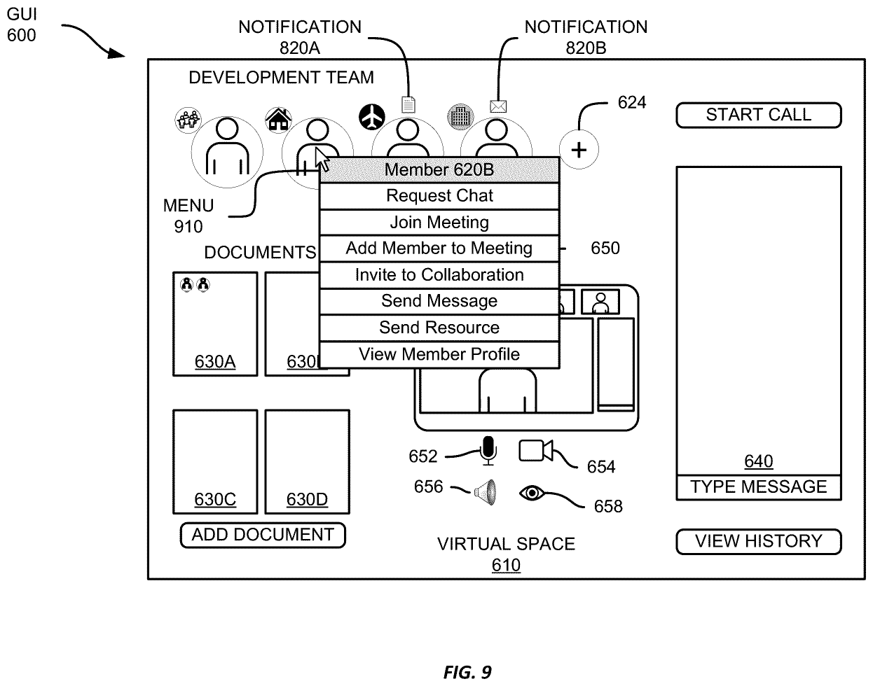

Referring now to FIG. 9, FIG. 9 shows another view of the GUI 600 from FIG. 6. In this example, the user has selected a different member 620b, which is working from home, but is active in the space. As can be seen, many of the options discussed above with respect to FIG. 8 are also provided in the new menu 910. However, addition interactive options are also included, including an option to join the member to a meeting. For example, if the user is participating in a video conference via the virtual space 610 and they wish to have the member 620b join the meeting, they can view their presence and, because they are active and not otherwise occupied, the user has the option to add them to the meeting. Depending on settings within the virtual space 610 or the member's own preferences, they may be immediately added to the meeting or may be asked if they consent to being added to the meeting. In addition, the user is presented with the option to invite the member 620b to a collaboration session, such as with respect to one or more of the available documents 630a-d within the virtual space 610 or within an app that has been attached to the space. However, because the member's presence indicates that they are working from home, no option is present for locating the member 620b within the office, as was available for member 620a in FIG. 8.

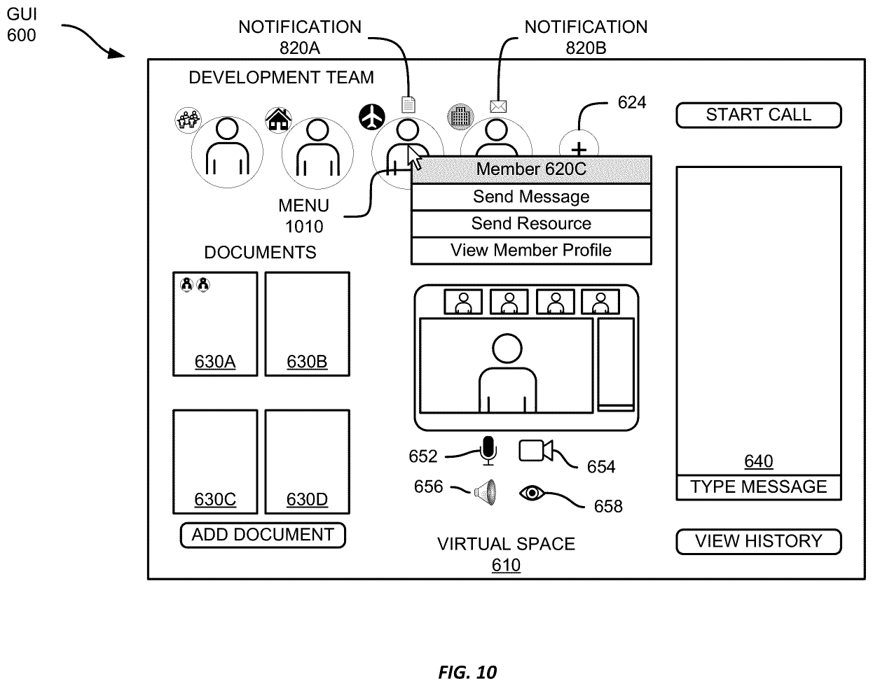

Referring now to FIG. 10, the GUI 600 shows that the user has selected member 620c, whose presence indicates that they are traveling and not connected to the virtual space 610. Thus, the range virtual space 610 has restricted the available options to only those that do not require interaction with the member 620c— sending a message or sending a resource to the member 620c, or viewing the member's profile. Thus, as with the examples shown in FIGS. 8 and 9, the virtual space 610 has determined available interaction options based on the member's presence.

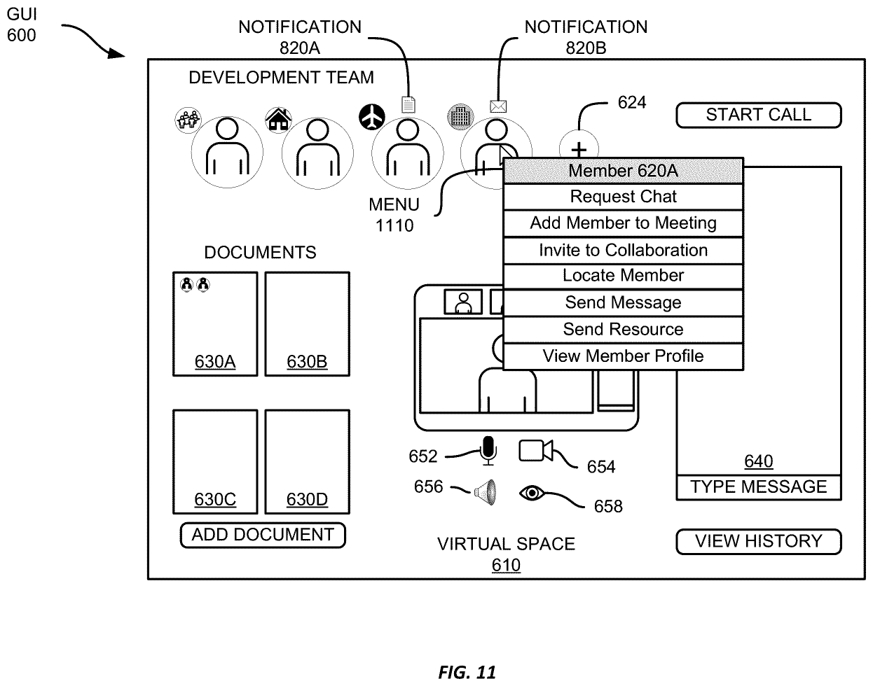

Referring to FIG. 11, the GUI 600 now shows a menu 1110 created in response to the user interacting with another member 620d of the virtual space 610. In this example, the member 620d is in the office and connected to the virtual space 610, but is not interacting with it, as discussed above with respect to FIG. 6. However, the range of options presented includes both interactive and non-interactive options. This example virtual space 610 allows interactive selections for members that are connected, but not active in the space. If the user selects an interactive option, such as to request a chat, add the member 620d to a meeting, or invite the member 620d to a collaboration, the member 620d may receive an indication that the virtual space has an interactive request pending for them, such as by flashing a tab corresponding to the virtual space 610, or other representation of the virtual space 610, in their software client. In addition, and similar to the example shown in FIG. 8, because the member's presence indicates that they are present in the office, the menu 1110 provides the option to locate the member 620d within the office. However, because the member 620d is not in a meeting, like member 620a, the option to join the meeting is not provided.

Thus, the examples shown in FIGS. 8-11 show how a member's presence within a virtual space can affect how other members are able to interact with them. Presence can therefore provide nuanced information about a member's current state with respect to the virtual space 610 and can affect how the virtual space 610 allows other members to interact with them. Thus, the virtual space, by determining the various members' presences as discussed herein, it provides both useful information to other members, but also affects the functionality of the virtual space 610.

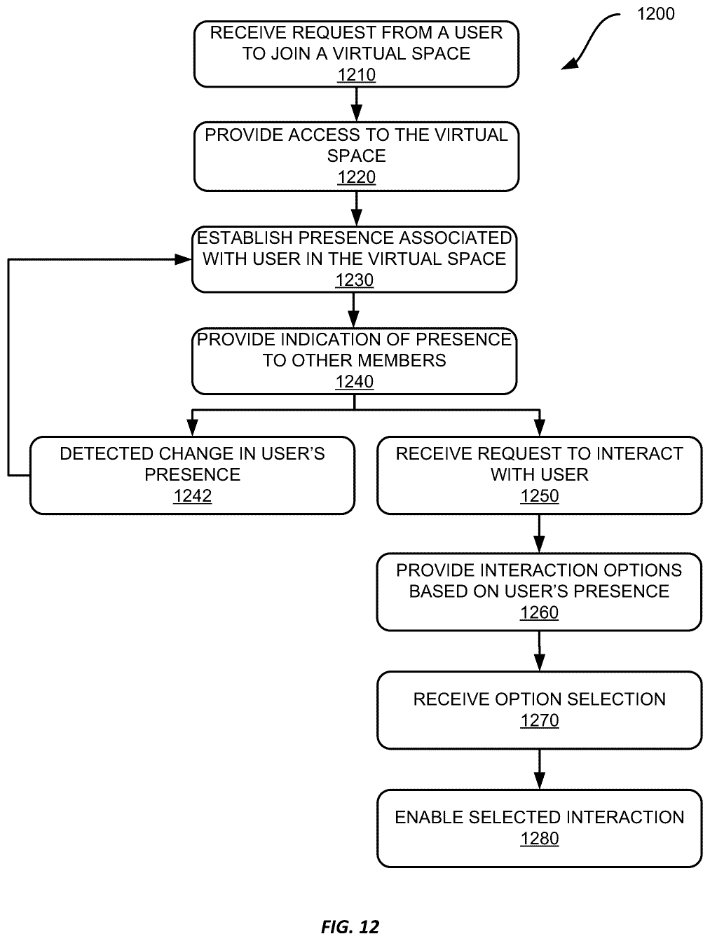

Referring now to FIG. 12, FIG. 12 shows another method 1200 for providing persistent hybrid virtual collaborative workspaces. The example method 1200 will be described with respect to the system shown in FIG. 3, the client device shown in FIG. 7, and the GUI 610 shown in FIGS. 6 and 8-12; however, any suitable systems or GUIs according to this disclosure may be employed, such as the systems of FIGS. 1-3

At block 1210, the virtual conference provider 310 receives a request from a user to join a virtual space 610. For example, a user may access a video conferencing application executing on their client device, e.g., client device 340a-b, 710, and select the virtual space 610 from one or more available virtual spaces 350. The request may then include information about the user, such as a username, an email address, or an employee identifier. If the user has not logged into an account with the virtual conference provider 310 or otherwise established a verified identity, such as via a user identity provider 115, 215, the virtual conference provider 310 may transit a request that the user log into a suitable account to verify their identity.

At block 1220, the virtual conference provider 310 provides access to the virtual space 610 to the user. For example, the virtual conference provider 310 may provide indications of one or more other members of the virtual space 610, one or more available resources, one or more conferences in-progress, or chat message activity. The user's client device may receive the indications and generate a GUI 600 including representations of some or all of these parts of the virtual space 350.

At block 1230, the virtual conference provider 310 establishes a presence associated with the user in the virtual space 610. In this example, the virtual conference provider 310 determines whether the user is connected to the virtual conference provider 310, and if so, whether the user is connected to a particular virtual space, e.g., space 610. It may also access other information related to the user, such as calendar information, including meeting schedules, day-of-week and time-of-day information, and holiday information. It may also access location information, such as location information previously received from the user's client device, e.g., GPS coordinates, IP address, or internet service provider information. It may access still other information as well.

Based on such information, it may establish a presence, at least in part, where the user is “not present,” or “connected, but not present,” (if the user is connected to the virtual conference provider, but not connected to the space 610, or “connected, but not interacting,” (e.g., if the user is connected to the virtual space, but it is in the background on their client device. Alternatively, it may establish the presence, at least in part, where the user is “connected and present, but idle” in the virtual space 610 or “connected and present and interacting.” In addition, based on other information obtained about the user, it may also provide additional context information, such as it may be a holiday in the user's locale, it may be after work hours, the user may have a scheduled appointment outside of the virtual space, they may be in a meeting or working with an app or resources, it may be a weekend, etc. The context information may be used to select an icon or icons that may be used to generate a visual indicator for the user's presence, such as later in the method 1200.

At block 1240, the virtual conference provider 310 provides an indication of the user's presence to other members of the virtual space 610. For example, the virtual conference provider 310 may transmit messages to other members who are connected to the virtual space 610 that identifies the user's presence, including related context. For any members that are connected to the space, or that later connect to the space, their client devices receive the indication and generate and output a presence indicator corresponding to the user's presence, which include a color coding, textual description of the presence, an icon, or any combination of these. Further, one or more of the client devices may output other stimuli, such as sounds, haptic vibrations, or flash the visual indicator to indicate the user's presence or changed presence.

At block 1242, the virtual conference provider 310 may determine that the nature of the user's presence may have changed. For example, the user may have had a “connected, but not interacting” presence due to the virtual space being placed in the background on the user's client device. If the user then brings the virtual space to the foreground, the virtual conference provider may receive a message from the client software executed by the user's client device that the user has focused the virtual space in the foreground. Similarly, if the virtual conference provider 310 determines based on calendar information that a meeting has begun, it may detect a possible change in the user's presence. Still any other detected change in context, connectivity, or focus, whether it was detected by the virtual conference provider or by the client device and communicated to the virtual conference provider, may be used. If a potential or actual change has been detected, the method returns to block 1230 to establish the user's presence based on the potential or actual change.

At block 1250, the virtual conference provider receives a request to interact with the user from another member of the virtual space 610. For example, another member may select the user's picture or other graphical representation and access a corresponding menu of interaction options. The member may then select one of the presented options to initiate a request to interact with the user. Alternatively, the member may interact with the user's representation in other ways, such as by dragging a resource on to the representation to share the resource or to request a collaboration session or video conference. They may drag the user's representation onto a resource or chat window or meeting to indicate a desire to work with the user on the resource or to interact with the user by text message or video conference. Still other inputs may be applied to indicate a request to interact with the user.

At block 1260, the virtual conference provider 310 provides interaction options to the member based on the user's presence. As discussed above with respect to FIGS. 8-11, the types and number of available interaction options presented with respect to a particular member, such as in a menu 810-1110, may vary based on the selected member's presence within the virtual space 610. The virtual conference provider 310 may provide multiple different interaction options for members who are present and active within the virtual space 610, while some options may be omitted for members who are either not present in the space, engaged in another interaction (e.g., in a meeting or video conference, whether attached to the virtual space or not), or are focused on a different virtual space or task. Similarly, depending on a location associated with a particular member, different options may be presented. For example, if the member is present at a corporate office, options to locate the member within the office may be provided; however, if the member is working from a remote location or is otherwise not present in the office, location options may be limited or omitted entirely. Still further subsets of options may be presented with respect to different members based on the functionality available within the virtual space 610 or based on the user's presence or associated context.

And while in this example, the virtual conference provider 310 determines which interaction options are available for a particular member and provides those options to the requesting user's client software, in other examples, the client software itself may determine which interaction options are available based on a particular member's presence. In some such examples, the virtual conference provider 310 may not perform block 1260 and instead may proceed directly to block 1270.

At block 1270, the virtual conference provider 1270 receives a selection of an interaction option from the user. For example, the user may select an option from a menu 810-1110 or they may directly act upon the particular member's representation, such as by dragging a resource, such as a document or video conference, onto the member's representation or dragging the member's representation onto a resource. Such an action may implicitly request an interaction with the member, or it may present a reduced set of options in a menu specific to the member and the identified resource. For example, if a user drags a document on a member's graphical representation, a menu may be displayed that provides options to share the document with the member or to collaborate on the document with the member.

At block 1280, the virtual conference provider enables the requested interaction. For example, if the user requested a video conference with the member, the virtual conference provider 310 establishes a video conference and joins the user and the member to the video conference. Similarly, if the user requested to collaborate on a document with the member, the virtual conference provider may establish a collaboration session with the user and the member and include the document. A collaboration session may employ an application that is attached to the space, such as a word processing application. The virtual conference provider may send an indication to the client software executed at both the user's client device and the member's client device of the type of document to be accessed and the respective client software instances may then launch the appropriate application.

In some examples, the selected option may not trigger a real-time interaction with the member themselves, but instead the interaction may be to share a document or resource or to access profile information for the member. Such interactions may be with the member, but are time-shifted such that the member may receive a notification of the shared document or resource, but may not access the document or resource immediately or even in a shared interaction with the user. Thus, any available option may be selected and enabled by the virtual conference provider 310.

It should be appreciated that because a virtual space is a dynamic collaborative workspace, methods according to this disclosure may occur repeatedly over time and multiple different instances of the method may occur at any particular time between any number of members of the virtual space. Further, the execution paths discussed above may vary according to different implementations.

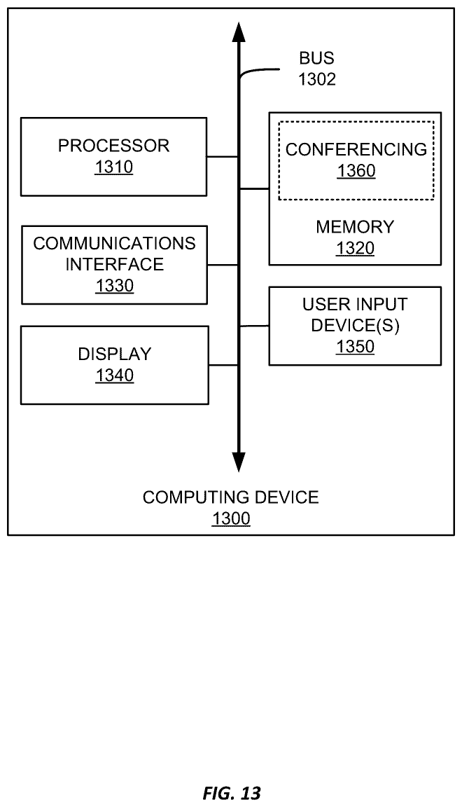

Referring now to FIG. 13, FIG. 13 shows an example computing device 1300 suitable for use in example systems or methods for providing presence in persistent hybrid virtual collaborative workspaces according to this disclosure. The example computing device 1300 includes a processor 1310 which is in communication with the memory 1320 and other components of the computing device 1300 using one or more communications buses 1302. The processor 1310 is configured to execute processor-executable instructions stored in the memory 1320 to perform one or more methods for providing presence in persistent hybrid virtual collaborative workspaces according to different examples, such as part or all of the example method 1200 described above with respect to FIG. 12. The computing device 1300, in this example, also includes one or more user input devices 1350, such as a keyboard, mouse, touchscreen, microphone, etc., to accept user input. The computing device 1300 also includes a display 1340 to provide visual output to a user.

In addition, the computing device 1300 includes a video conferencing application 1360 to enable a user to join and participate in one or more virtual spaces or in one or more conferences, such as a conventional conference or webinar, by receiving multimedia streams from a video conference provider, sending multimedia streams to the video conference provider, joining and leaving breakout rooms, creating video conference expos, etc., such as described throughout this disclosure, etc.

The computing device 1300 also includes a communications interface 1340. In some examples, the communications interface 1330 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

1. A method comprising:
receiving, from a client device by a conference provider, a request to join a virtual space hosted by the conference provider, the virtual space having a plurality of members, the client device associated with a first member of the plurality of members;
joining the client device to the virtual space;
establishing a presence associated with the first member based on an interaction of the first member with the virtual space, the presence indicating whether the first member is present in the virtual space and a context indicating an interaction with the virtual space; and
providing an indication of the presence to the other members of the plurality of members.

2. The method of claim 1, further comprising:
maintaining, by the conference provider, a plurality of virtual spaces, the virtual space being a first virtual space of the plurality of virtual spaces, and wherein the first member is a member of a first plurality of virtual space of the plurality of virtual spaces; and
wherein the presence is a first presence and establishing the presence comprises:
establishing a plurality of presences associated with the first member, each presence associated with one of the first plurality of virtual spaces;
adjusting the first presence to indicate that the first member is present in the first virtual space; and
adjusting the other presences of the plurality of presences to indicate that the first member is not present in the other virtual spaces of the first plurality of virtual sp aces.

3. The method of claim 2, further comprising:
receiving, from the client device by the conference provider, a second request to join a second virtual space of the plurality of virtual spaces, the second virtual space having a second plurality of members;
joining the client device to the second virtual space;
adjusting the first presence to indicate that the first member is not present in the first virtual space;
adjusting a second presence associated with the second virtual space to indicate that the first member is present in the second virtual space; and
adjusting the other presences of the plurality of presences to indicate that the first member is not present in the other virtual spaces of the first plurality of virtual spaces.

4. The method of claim 1, further comprising:
receiving, from the client device, a request to join a conference attached to the virtual space;
joining the client device to the conference;
adjusting the presence based on joining the client device to the conference;
updating the indication of the presence based on the adjusting; and
providing the updated indication.

5. The method of claim 1, wherein the client device is associated with a conference room, and further comprising:
attaching the conference room to the virtual space;
detecting the first member within the conference room; and
wherein establishing the presence is based on the detecting.

6. The method of claim 1, further comprising:
receiving, from a second client device associated with a second member of the virtual space, a request to interact with the first member;
providing one or more interaction options;
receiving a selected interaction option;
responsive to receiving approval of the requested indication from the first member, enabling the requested interaction between the first and second members.

7. The method of claim 1, wherein the context indicates one or more of a location context, a calendar context, a time-of-day context, or a holiday context.

8. A system comprising:
a communications interface;
a non-transitory computer-readable medium; and
one or more processors communicatively coupled to the non-transitory computer-readable medium, the one or more processors configured to execute processor-executable instructions stored in the non-transitory computer-readable medium to:
receive, from a client device by a conference provider, a request to join a virtual space hosted by the conference provider, the virtual space having a plurality of members, the client device associated with a first member of the plurality of members;
join the client device to the virtual space;
establish a presence associated with the first member based on an interaction of the first member with the virtual space, the presence indicating whether the first member is present in the virtual space and a context indicating an interaction with the virtual space; and
provide an indication of the presence to the other members of the plurality of members.

9. The system of claim 8, wherein the presence is a first presence and wherein the one or more processors are configured to execute further processor-executable instructions stored in the non-transitory computer-readable medium to:
maintain, by the conference provider, a plurality of virtual spaces, the virtual space being a first virtual space of the plurality of virtual spaces, and wherein the first member is a member of a first plurality of virtual space of the plurality of virtual spaces;
establish a plurality of presences associated with the first member, each presence associated with one of the first plurality of virtual spaces;
adjust the first presence to indicate that the first member is present in the first virtual space; and
adjust the other presences of the plurality of presences to indicate that the first member is not present in the other virtual spaces of the first plurality of virtual spaces.

10. The system of claim 9, wherein the one or more processors are configured to execute further processor-executable instructions stored in the non-transitory computer-readable medium to:
receive, from the client device by the conference provider, a second request to join a second virtual space of the plurality of virtual spaces, the second virtual space having a second plurality of members;
join the client device to the second virtual space;
adjust the first presence to indicate that the first member is not present in the first virtual space;
adjust a second presence associated with the second virtual space to indicate that the first member is present in the second virtual space; and
adjust the other presences of the plurality of presences to indicate that the first member is not present in the other virtual spaces of the first plurality of virtual spaces.

11. The system of claim 8, wherein the one or more processors are configured to execute further processor-executable instructions stored in the non-transitory computer-readable medium to:
receive, from the client device, a request to join a conference attached to the virtual space;
join the client device to the conference;
adjust the presence based on joining the client device to the conference;
update the indication of the presence based on the adjusting; and
provide the updated indication.

12. The system of claim 8, wherein the client device is associated with a conference room, and wherein the one or more processors are configured to execute further processor-executable instructions stored in the non-transitory computer-readable medium to:
attach the conference room to the virtual space;
detect the first member within the conference room; and
wherein the presence is further based on the detecting.

13. The system of claim 8, wherein the one or more processors are configured to execute further processor-executable instructions stored in the non-transitory computer-readable medium to:
receive, from a second client device associated with a second member of the virtual space, a request to interact with the first member;
provide one or more interaction options;
receive a selected interaction option;
responsive to receiving approval of the requested indication from the first member, enable the requested interaction between the first and second members.

14. The system of claim 8, wherein the context indicates one or more of a location context, a calendar context, a time-of-day context, or a holiday context.

15. A non-transitory computer-readable medium comprising processor-executable instructions configured to cause one or more processors to:
receive, from a client device by a conference provider, a request to join a virtual space hosted by the conference provider, the virtual space having a plurality of members, the client device associated with a first member of the plurality of members;
join the client device to the virtual space;
establish a presence associated with the first member based on an interaction of the first member with the virtual space, the presence indicating whether the first member is present in the virtual space and a context indicating an interaction with the virtual space; and
provide an indication of the presence to the other members of the plurality of members.

16. The non-transitory computer-readable medium of claim 15, wherein the presence is a first presence, and further comprising processor-executable instructions configured to cause the one or more processors to:
maintain, by the conference provider, a plurality of virtual spaces, the virtual space being a first virtual space of the plurality of virtual spaces, and wherein the first member is a member of a first plurality of virtual space of the plurality of virtual spaces;
establish a plurality of presences associated with the first member, each presence associated with one of the first plurality of virtual spaces;
adjust the first presence to indicate that the first member is present in the first virtual space; and
adjust the other presences of the plurality of presences to indicate that the first member is not present in the other virtual spaces of the first plurality of virtual spaces.

17. The non-transitory computer-readable medium of claim 16, wherein the virtual space is a first virtual space, and further comprising processor-executable instructions configured to cause the one or more processors to:
receive, from the client device by the conference provider, a second request to join a second virtual space of the plurality of virtual spaces, the second virtual space having a second plurality of members;
join the client device to the second virtual space;
adjust the first presence to indicate that the first member is not present in the first virtual space;
adjust a second presence associated with the second virtual space to indicate that the first member is present in the second virtual space; and
adjust the other presences of the plurality of presences to indicate that the first member is not present in the other virtual spaces of the first plurality of virtual spaces.

18. The non-transitory computer-readable medium of claim 15, wherein the virtual space is a first virtual space, and further comprising processor-executable instructions configured to cause the one or more processors to:
receive, from the client device, a request to join a conference attached to the virtual space;
join the client device to the conference;
adjust the presence based on joining the client device to the conference;
update the indication of the presence based on the adjusting; and
provide the updated indication.

19. The non-transitory computer-readable medium of claim 15, wherein the client device is associated with a conference room, and wherein the virtual space is a first virtual space, and further comprising processor-executable instructions configured to cause the one or more processors to:
attach the conference room to the virtual space;
detect the first member within the conference room; and
wherein the presence is further based on the detecting.

20. The non-transitory computer-readable medium of claim 15, wherein the virtual space is a first virtual space, and further comprising processor-executable instructions configured to cause the one or more processors to:
receive, from a second client device associated with a second member of the virtual space, a request to interact with the first member;
provide one or more interaction options;
receive a selected interaction option;
responsive to receiving approval of the requested indication from the first member, enable the requested interaction between the first and second members.
